(19) United States
(12) Patent Application Publication
(10) Pub. No.: US 2008/0022304 A1
(43) Pub. Date: Jan. 24, 2008

(54) Digital Media Device Having Selectable Media Content Storage Locations

(75) Inventors: Bohdan S. Prus, Alpharetta, GA (US); Samuel H. Russ, Lawrenceville, GA (US)

Correspondence Address: SCIENTIFIC-ATLANTA, INC.;THOMAS, KAYDEN, HORSTEMEYER & RISLEY, 5030 SUGARLOAF PARKWAY, LAWRENCEVILLE, GA, 30044, US

(73) Assignee: Scientific-Atlanta, Inc., Lawrenceville, GA (US)

(21) Appl. No.: 11/428,357

(22) Filed: Jun. 30, 2006

(51) Int. Cl. H04N 7/173; H04N 5/445; G06F 3/00; G06F 13/00

(52) U.S. Cl. 725/39; 725/86; 725/37; 725/38

(57) ABSTRACT

A digital media device having selectable media content storage locations, and associated methods, are disclosed. One exemplary method includes displaying a plurality of instances of media content available to be stored to a plurality of storage locations associated with a digital media device in a graphical user interface provided by the digital media device and receiving a user selection of an instance of media content from the plurality of instances of media content displayed in the graphical user interface. The exemplary method further includes displaying, in response to receiving the user selection of the instance of media content from the plurality of instances of media content, a selection of one of the plurality of storage locations to which to store the selected instance of media content. The method further includes receiving a user selection of one the plurality of storage locations to which to store the selected instances of media content.

### CROSS-REFERENCE TO RELATED APPLICATIONS

This application is related to co-pending U.S. patent application entitled “Systems and Methods for Applying Retention Rules”, having Ser. No. ______ [Attorney Docket No. A-11166; 191930-1640] and filed on the same day as, and with identical inventorship as, the present application. The related co-pending patent application listed above is hereby incorporated by reference in its entirety into the present disclosure.

### BACKGROUND

1. Technical Field

The present disclosure generally relates to digital media recording devices, and more specifically, to managing media content associated with a digital media recording device.

2. Description of the Related Art

Digital media recording devices can be used for recording media signals, such as audio and/or video signals, in a digital format. Such devices may also be used for the storage and playback of such signals. Specific examples of such digital media recording devices are a Digital Video Recorder (DVR) and a Personal Video Recorder (PVR).

In general, a DVR may be used to schedule and record future television programs, for buffering live television programs in a time-shift buffer, and/or playback of the digitally recorded media. The incoming media signals may be received, potentially decrypted and/or encoded, and digitally stored on a storage medium. The storage medium is commonly a non-volatile storage device such as a hard disk drive (HDD) (i.e., hard drive), among other acceptable mediums. Such an HDD can write the digital media data on a magnetic surface of the HDD disk platters and read the media data at later times for playback.

Conventional DVRs include an HDD located inside the housing of the DVR for storing the media data. This HDD may also have catalog information related to the media data stored on the HDD. The catalog information may include information about associated media data, such as guide information (i.e., title, actors, genre, program description, channel, time, etc.), recording date, and/or trick play information.

Some DVRs include the capability of attaching external storage devices (e.g. an HDD) to the DVR through a communication interface. However, because the external storage devices may be connected and/or disconnected from the DVR, special considerations for managing the media content stored to the devices are needed.

Furthermore, conventional DVRs abstract the storage location of media content from users. In that DVRs can include multiple storage locations for media data, such as an internal and external storage device and/or multiple internal or external storage mediums, for example, it can be potentially beneficial to remove this abstraction in order to allow the user to manage the media content stored to such locations.

Accordingly, the present disclosure includes a number of potential embodiments for carrying out media content management in such an environment.

### BRIEF DESCRIPTION OF THE DRAWINGS

The components in the drawings are not necessarily to scale relative to each other. Like reference numerals designate corresponding parts throughout the several views.

FIG. 1 depicts a block diagram of an arrangement of a digital video recorder (DVR) in accordance with embodiments of the present disclosure.

FIG. 2 depicts a block diagram of selected system components of an exemplary embodiment of the DVR of FIG. 1.

FIG. 3 depicts a simplified block diagram of an exemplary embodiment of the DVR of FIGS. 1 and 2.

FIG. 4 depicts a screen shot of an exemplary programming guide display that can be provided in a graphical user interface (GUI) of the DVR of FIGS. 1-3.

FIG. 5 depicts another embodiment of a display provided by the DVR of FIGS. 1-3 that includes a user interface for recording an instance of media content.

FIG. 6 depicts another embodiment of a display provided by the DVR of FIGS. 1-3 that lists previously recorded instances of media content.

FIG. 7 depicts another exemplary display provided by the DVR of FIGS. 1-3 that provides a user interface for transferring selected instances of media content from a first storage location to a desired storage location.

FIG. 8 depicts another exemplary display provided by the DVR of FIGS. 1-3 that displays an updated listing of previously recorded instances of media content after transferring the selected shows to the desired storage location.

FIG. 9 depicts another exemplary display provided by the graphical user interface of the digital media device and providing a user interface for sorting or filtering the displayed instances of media data by its associated storage location.

FIG. 10 depicts an embodiment of an exemplary updated display after the DVR has filtered the plurality of instances of media content by the selected storage location of FIG. 9.

FIG. 11 depicts an embodiment of an exemplary display provided by the DVR of FIGS. 1-3 that provides a user interface that can be used for deleting an instance of media content from a selected storage location.

FIG. 12 depicts another embodiment of an exemplary display provided by the DVR of FIGS. 1-3 and depicting an updated display after deleting the selected instance of media content through the user interface of FIG. 11.

FIG. 13 depicts a flow diagram of an exemplary process for selecting the storage location of media content using a digital media device, such as the DVR of FIGS. 1-3.

FIG. 14 depicts a process flow diagram of another exemplary process for selecting the storage location of previously recorded media content using the digital media device, such as the DVR of FIGS. 1-3.

FIG. 15 depicts a process flow diagram of one exemplary operation that can be performed on the instances of previously recorded media content displayed according to the flow diagram of FIG. 14.

FIG. 16 depicts another embodiment of a process flow diagram of an exemplary operation that can be performed on the instances of previously recorded media content displayed according to the flow diagram of FIG. 14.

FIG. 17 depicts another embodiment of a process flow diagram of an exemplary operation that can be performed on the instances of previously recorded media content displayed according to the flow diagram of FIG. 14.

### DETAILED DESCRIPTION

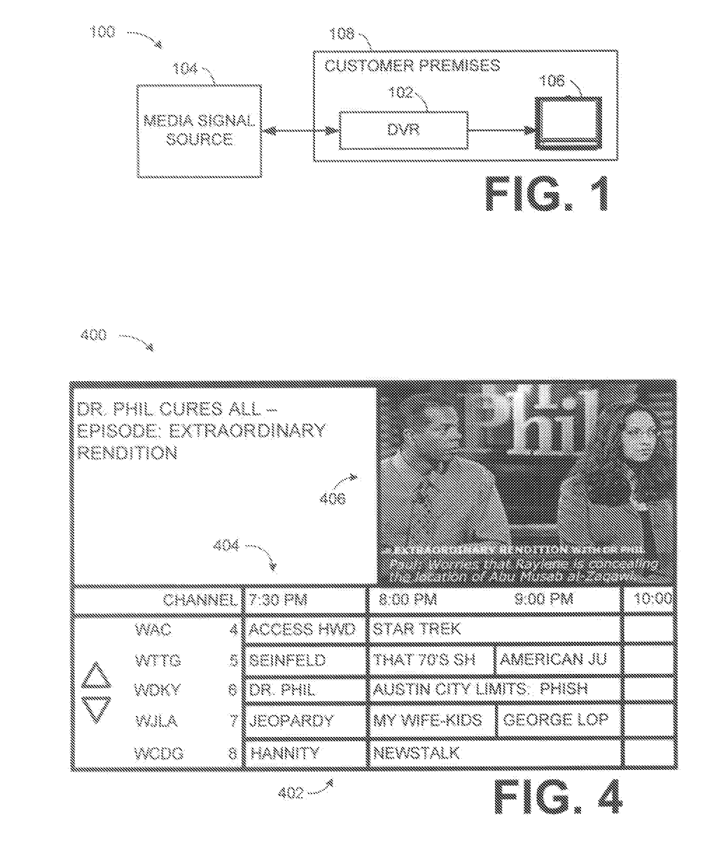

FIG. 1 depicts an embodiment of an arrangement 100 of a digital media recording system in accordance with selected embodiments of the present disclosure, among others. According to some embodiments, the digital media recording system includes a digital media device configured to record media content, such as, among others, video and/or audio content. For example, such a digital media device is depicted in FIG. 1 as digital video recorder (DVR) 102. However, according to some embodiments, the digital media device is, among other devices used for recording digital media, a personal video recorder (PVR), a personal digital recorder (PDR), a personal computer, laptop computer, and/or personal digital assistant (PDA), among other electronic devices configured to execute media recording capabilities.

According to some embodiments, DVR 102 is also embedded within, or otherwise associated with, other electronic devices such as a cable television set-top box (STB), a tuner, a television, and/or a satellite-television receiver, or a playback device, such as a television, among others.

Media content is also referred to herein as media programs or media programming. Some examples of media programming used herein include, but are not intended to be limited to, television programs and radio programs. An instance of media programming or media content could be, for example, a recording of a television show (e.g., an episode of Smallville). A series of media programming could be, for example, a number of episodes of a television show (e.g., the last five recordings of Smallville).

The media content is recorded by the digital media recorder and stored as media data. In some instances, such media data is encoded audio and/or video signals, among other representations of the media content that is in a form suitable for processing by DVR 102. Such media signals could be analog and/or digital signals.

DVR 102 is configured to receive media signals from a media signal source 104, and is also in communication with a playback device, such as television 106, among other devices capable of emitting or displaying media. Thus, one of ordinary skill in the art will appreciate that, according to some embodiments, the playback device can comprise any of the following (or other) types of devices configured to support a graphical user interface (GUI): a computer monitor, a liquid crystal display (LCD), a plasma-based display, an LED-based display, a touch-sensitive screen, such as those implemented in portable computing devices (e.g., a personal digital assistant (PDA)), and any other known or future display device, regardless of the underlying display technology. According to some embodiments, the playback device could also include an audio emitting device.

Media signal source 104 is any of a number of sources of analog and/or digital media signals, such as video and/or audio signals. According to some embodiments, media signal source 104 is, for example, among others, a satellite television source, an over-the-air broadcast source, a cable-television (CATV) system, or a server configured to stream, or otherwise provide, media signals over a network (i.e., LAN, WAN, Internet, etc.).

In some instances, media signal source 104 also transmits additional network data, including Internet traffic, teletext, closed-captioning, and/or programming information, among others. Media signal source 104 transmits such signals to DVR 102, which is located in one implementation, among others, remotely at a customer premises 108. Although only one media signal source is depicted, in some embodiments DVR 102 receives media signals from more than one media signal source. For example, in one such embodiment, DVR 102 receives signals from a CATV system as well as an over-the-air antenna.

Television 106 receives and emits signals from DVR 102 that represent the recorded (and unrecorded) media signals. For example, television 106 emits, among others, recorded audio and/or video signals. According to some embodiments, television 106 also displays any windows associated with a graphical user interface generated by DVR 102.

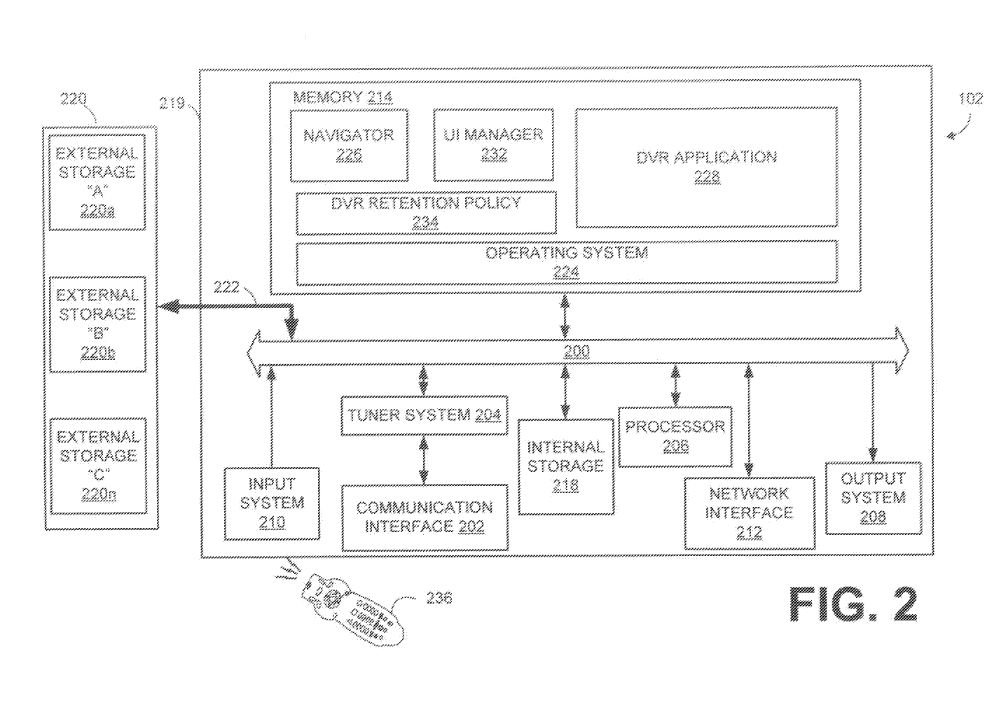

FIG. 2 is a block diagram depicting selected system components of an exemplary embodiment of the DVR 102 of FIG. 1. Omitted from FIG. 2 are a number of conventional components, known to those skilled in the art, that are unnecessary to explain the operation of the disclosed systems and methods for applying media retention rules. FIG. 2 depicts several components commonly communicating through a local bus 200. For example, DVR 102 includes a communications interface 202 for receiving video, audio and other media signals and, potentially, programming information from media signal source 104 (FIG. 1). Communications interface 212 comprises, for example, an Ethernet interface, an IEEE-1394 interface, a USB (Universal Serial Bus) interface, a serial interface, a parallel interface, a wireless radio frequency (RF) interface, a telephone line interface, a power-line interface, a coaxial cable interface, and/or an infrared (IR) interface, among others.

DVR 102 also includes a tuner system 204 for receiving and selecting one or more selected channels or streams of media content. For example, according to some instances, tuner system 204 can tune to a particular television channel or stream, and the media signals associated with this channel or stream are recorded by the DVR 102.

DVR 102 further includes at least one processor 206 for controlling the operations of the DVR 102 and an output system 208 for driving a playback device (e.g., television 106). An input system 210 receives user inputs provided via a wired or wireless input device 236 such as, for example, a hand-held remote control, a mouse, a joystick, a transmitter with buttons or keys located on the exterior of the DVR, and/or a keyboard, among other potential input devices.

Network interface 212 transmits and/or receives data over a network such as a LAN, WAN, or the Internet. For example, data is transferred to/from another DVR, a media signal source, or a centralized server through network interface 212, among others. Memory 214, which can include volatile and/or non-volatile memory, stores one or more programmed software applications, routines, drivers, or other functional elements (herein broadly referred to as applications), which contain instructions that are executed by processor 206 under the direction of operating system 216. Input data used by an application is stored in memory 214 and read by processor 206 as needed during the course of the execution of the application. In some instances, this input data is data stored in memory 214 by a secondary application or other source, either internal or external to DVR 102. In other stances, data is created with the application at the time it was generated as a software application program. According to some embodiments, other logic is stored in memory 212 for operation of the DVR 102.

Internal storage 218 comprises a recordable medium and may be any of a number of devices available for non-volatile data storage, such as, among others, a hard disk drive (HDD), optical drive, or flash memory, for example. Although depicted as separate components, internal storage 218 and memory 214 are the same device in some embodiments. Among other uses, internal storage 218 is used for storing media content (i.e. in the form of media data) received through communication interface 202 and/or network interface 212. In some embodiments, before being stored on the recordable medium, the media content is digitally encoded by the DVR itself or by means external from the DVR, such as the media signal source or a cable set-top box. Media content is stored on the recordable medium in an encrypted or unencrypted state.

Like internal storage 218, external storage 220 also comprises a recordable medium for non-volatile data storage, such as, among others, a hard disk drive (HDD), optical drive, or flash memory, for example. However, unlike internal storage 218, which is located within the DVR enclosure (i.e., housing) 219, external storage 220 can be removably attached to DVR 102 through a communications interface 222. According to some embodiments, external storage 220 is located remotely from the DVR, such as in other rooms or locations within a house.

Although only one external storage medium is used in some embodiments, it is contemplated that other embodiments may comprise a plurality of external storage mediums 220a-220n, which may be considered separate storage locations. In some instances, for example, external storage mediums 220a-220n comprise a plurality of HDDs. It can be appreciated that the one or more HDDs can be combined to communicate with DVR 102 over one or more communication interfaces using a hub or other similar device. According to some embodiments, the external storage 220 is provided in a self-supporting, external housing. Some embodiments also include an integrated power supply for powering to the external storage and/or cooling devices, such as fans and/or heat dissipating devices.

Within the context of this document, a storage location for media content can comprise, among others, a specific storage device and/or a storage medium. The specific storage device could be one or several internal and/or external HDDs, among other storage devices. A storage location could also represent one of several storage mediums to which media content can be stored. For example, a single external or internal storage device could comprise a plurality of storage mediums. Furthermore, an external storage device can include a first storage medium, and an internal storage device can include a second storage medium, the first and second storage mediums comprising different storage locations.

According to some embodiments, communication interface 222 can be a high-speed communication bus, such as, among others, a bus operating under the Advanced Technology Attachment (ATA) standard, and more specifically, the Serial-ATA (i.e., SATA) standard version 2.5, which is available from the Serial ATA International Organization and is hereby incorporated by reference in its entirety. According to such an embodiment, DVR 102 includes a communications interface comprising an attachment port on the housing 219 of the DVR that cooperatively mates with the plug of external storage 220. A cable complying with the high-speed bus (i.e., a cable complying with the SATA standards) provides the transmission medium between external storage 220 and DVR 102.

According to some embodiments, the communication interface 222 is a bus complying with wired infrastructure and protocols, such as, for example, the IEEE 1394 (Firewire) standard or the Universal Serial Bus (USB) standard, among others. However, in some instances, the communication interface 222 is a wireless medium. According to one such a wireless embodiment, the external storage device 220 communicates with DVR 102 using a wireless protocol such as the IEEE 802.11 protocol, among others.

Some embodiments of DVR 102 include a communications interface comprising a slot or port for readily removable media. The readily removable media is, for example, flash memory, an HDD, optical media, and/or magnetic media, among others.

User input received during the course of execution of any processes implemented by DVR 102 are received from an input device 236 via input system 210, transmitted through the bus 200, at least temporarily stored within memory 214, and communicated to processor 206. Data generated by an application is stored in memory 214 by processor 206 during the course of the execution of the application. Availability, location, and amount of data generated by one application for consumption by another application is communicated by messages through the services of operating system 224, among others. Hence, preferences for the operation of the DVR functions is input by, among others, a subscriber using a remote and/or remotely under the control of an entity other than the user (e.g., by a command or other configuration change transmitted from the cable head-end). Changes to decision-making logic associated with the applications described herein are made by, among others, a variety of mechanisms under software control.

A navigator application 226 provides a navigation framework for services provided by DVR 102. Navigator 218 registers for, and in some cases reserves, certain user inputs related to navigational keys such as channel increment/decrement, last channel, favorite channel, etc. Navigator 218 also provides users with television (or other programming) related menu options that correspond to DVR functions such as, for example, providing an interactive program guide, blocking a channel or a group of channels from being displayed in a channel menu, recording particular channels, and playback of recorded shows, among other functions.

Under user instruction, DVR application 228 performs the general tasks of recording and/or playing back received media content. Among other functions, DVR application 228 manages media content and related information. For example, according to some embodiments, DVR application 228 determines when and to which storage location that the media content and related information will be stored. As well, as communication with storage devices is established or broken (e.g., by, among other possibilities, attaching and detaching external storage devices to the DVR 102), DVR application 228 performs a number of tasks to ensure that respective information associated with media content stored to the storage devices is managed accordingly.

Applications, such as navigator 226 and DVR application 228, among others, utilize services provided by user interface (UI) manager 232 and/or other graphics utilities provided by operating system 224 to draw dialog boxes, menus, graphics, etc., for display within a GUI on a playback device such as television 106. UI manager 232, which in one embodiment is part of operating system 224 and/or DVR application 228, contains functionality for allocating screen areas and managing screen use among the various applications. Accordingly, UI manager 232 provides the user interface for the DVR and the UI manager 232, among other potential software modules and/or hardware components, may be configured to enable a user to manipulate objects in a portion of a GUI via a display device (i.e. television 106) and the user input device 236.

The applications executed by DVR 102 comprise executable instructions for implementing logical functions. In some instances, the applications are embodied in any computer-readable medium for use by, or in connection with, an instruction execution system. Some embodiments of the instruction execution system are, for example, a computer-based system, a processor-containing system, or any other system capable of executing or interpreting instructions. In the context of this document, a “computer-readable medium” is any means that can contain, store, communicate, propagate, or transport the program for use by or in connection with the instruction execution system, apparatus, or device.

Some embodiments of the computer-readable medium are, for example, among others, an electronic, solid-state, magnetic, optical, electromagnetic, infrared, or semiconductor system, apparatus, device, or propagation medium, either internal to DVR 102 or externally connected to the DVR 102 via one or more communication ports or network interfaces. More specific examples (a non-exhaustive list) of the computer-readable medium would include the following: an electrical connection (electronic) having one or more wires, a portable computer diskette (magnetic), a hard drive storage device (magnetic), a random access memory (RAM) (solid-state device), a read-only memory (ROM) (solid-state device), an erasable programmable read-only memory (EPROM or Flash memory) (multiple devices), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

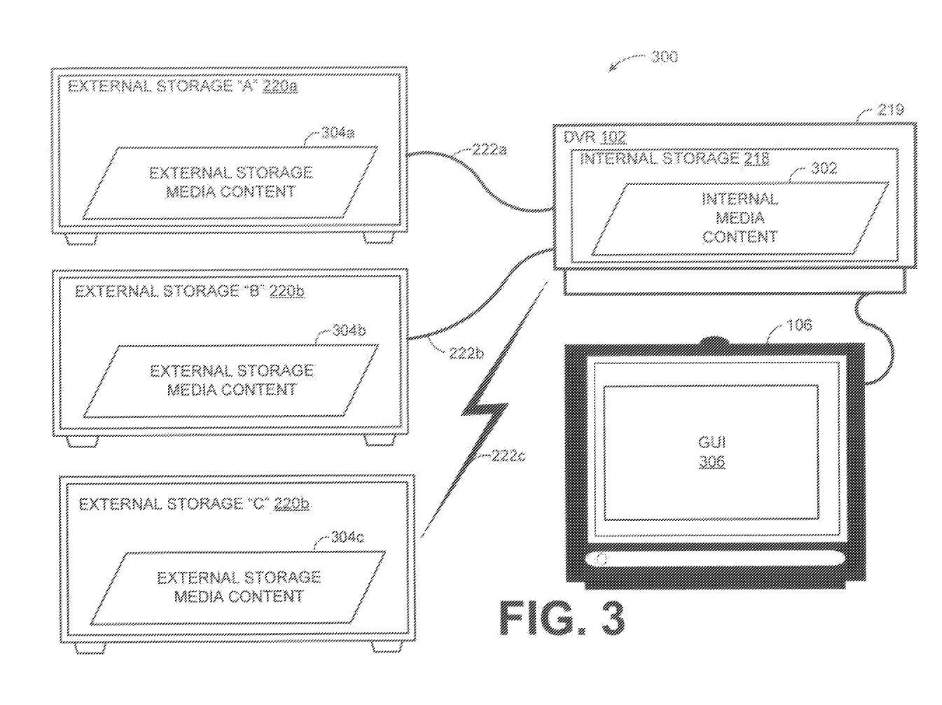

FIG. 3 depicts a simplified block diagram 300 of the DVR arrangement of FIGS. 1 and 2. Specifically, according to one embodiment, DVR 102 comprises internal storage 218 which can include a storage medium for storing internal media content 302. Internal storage 218 is located within the housing 219 of DVR 102. DVR 102 is in further communication with external storage “A” 220a, external storage “B” 220b and external storage “C” 220c. According to some embodiments, external storage “A” 200a, external storage “B” 220b and external storage “C” 200c are in communication with DVR 102 over communication interfaces 220a, 220b and 220c, which could be any wired or wireless communications interface. As depicted, external storage A 220a, external storage B 200b and external storage C 220c are physically located outside of the housing 219 of DVR 102. Furthermore, each of external storage 220a, 220b, and 220c is configured for storing external storage media content 304a, 304b, and 304c, respectively.

DVR 102 is also coupled to a display device, depicted as television 106, which can be configured for displaying or otherwise emitting the media content played back by DVR 102 and/or for providing a display of images within a GUI 306 provided by DVR 102. The GUI 306 may be generated through one or more of the UI manager 232, DVR application 228 and/or operating system 224, among other applications which offer modules that could be operating under the influence of DVR 102. The GUI be used for, among other uses, requesting user input with respect to various operations performed by DVR 102 and/or displaying information about the media content or other preferences and operations of the DVR 102.

According to some embodiments, DVR 102 is configured to display a program guide within the GUI 306. For example, looking to FIG. 4, an exemplary display 400 is depicted showing a plurality of instances of media content available to be recorded or otherwise stored to the internal or external storage 218 or 220 of DVR 102 at a future time. According to the embodiment of FIG. 4, the instances of media content capable of being recorded at a future time are listed in a time/channel grid 404. According to one such embodiment, a user may use the input device 236 in order to scroll vertically through available channels (some of which may not be depicted) and/or horizontally through available show times. Other display configurations are contemplated, including media “on-demand” systems which may, or may not, have any specified availability time. In some instances, a preview pane 406, can be used to display, for example, the media content appearing on a highlighted channel in time/channel grid 404. Preview pane 406 could also be used to view another instance of media content (i.e. media content delivered by the last selected channel or stream) while the user browses through available programming in the time/channel grid 404.

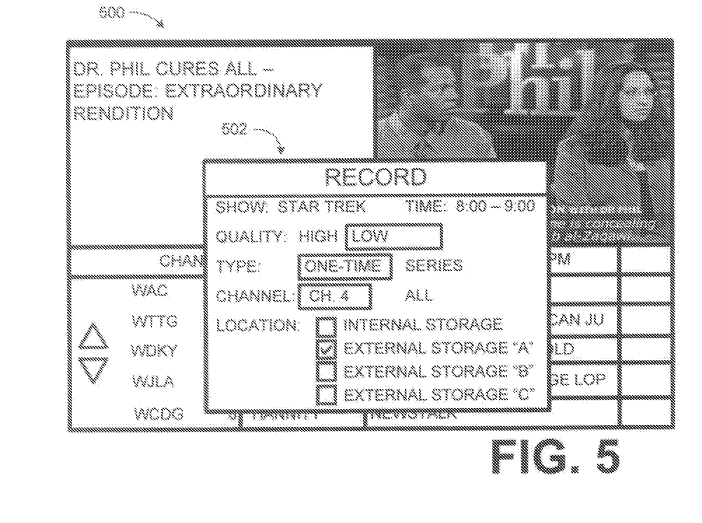

FIG. 5 depicts another exemplary display 500 which may be generated within the GUI 306 by DVR 102. Here, a user has selected one or more instances of media content to be recorded at a future time using the input device 236 (FIG. 2). An options display 502 user interface, displayed in response to this selection, is configured for receiving user input with respect to a number of recording options.

According to the exemplary options display 502, a user has selected the show Star Trek to record from 8:00 until 9:00 at low recording quality. In some instances, the user can indicate, through the user interface of options display 502, whether the DVR 102 is to record only this episode (e.g., a one-time record) or if DVR 102 is to record all shows in the series. Furthermore, according to some embodiments, the user may indicate whether to record the show only on the selected channel or all channels.

Furthermore, according to some embodiments, a user is provided with an option for storing the selected media content to one or more designated storage locations. For example, the user can indicate whether the instance of media content to be recorded is to be stored to internal storage 218, external storage “A” 220a, external storage “B” 220b and/or external storage “C” 220c. According to the embodiment depicted in FIG. 5, the user has selected (via the indicated check mark) that the instance of media content, Star Trek, is stored to external storage “A” 220a.

It should be understood that according to some embodiments, it may be desirable to store the instance, or instances, of media content to multiple locations. For example, in the present embodiment, by also selecting a check mark in the box to the left of “internal storage” in options display 502, the television show Star Trek can be recorded to both external storage “A” 220a and internal storage 218. Thus, according to such an embodiment, the user is provided with a back-up copy of the recorded instance of media content. Furthermore, by storing the instance of media content to external storage “A” 220a, assuming that any encryption and/or DRM limitations are satisfied, the instance of media content could be transported to other media devices for playback. That is, once the instance of media content is safely recorded, external storage “A” 220a can be disconnected from the DVR used to initially record the instance of media content and potentially connected to another DVR for playback.

Additionally, by allowing the user to direct desired media content to a specified storage location, a device or storage medium associated with the selected storage location can be used as a media content archive. This opens up the possibility of, for example, having dedicated storage locations for desired programming. Even further, directing media content to external storage 220 can save wear and tear on the internal storage 218 by directing read/write activity (i.e. HDD disk activity) outside of the housing of DVR 102. According to some DVR configurations, the reduction of disk activity on internal storage 218 can also help reduce operating temperatures within the housing 219 of DVR 102.

According to some embodiments, a user can set up recordings to be stored to a specified storage location based on a wide variety of criteria. For example, the user could indicate that instances of media content be stored to a specified storage medium based on program guide information. Media content associated with a genre (i.e. sports, children's shows, news, weather, etc.) could be designated as being stored to a specific storage location. Likewise, media content having an associated description that includes a specific keyword or which feature a favorite actor could be directed to a specified storage location. A wide variety of such criteria could be used and is intended to be covered within the scope of the present disclosure.

According to one specific example, a user could indicate that any instances of media content that provide international stock news and/or quotes be recorded to a portable external storage device during the hours that the user typically sleeps. When the user awakens, this portable external device could be disassociated from the DVR and taken with the user for playback during a morning commute to work via a personal media device (i.e. an iPod, portable digital media device, PDA, computer, etc.) or other playback device capable of reading the media content for playback from the portable external storage device.

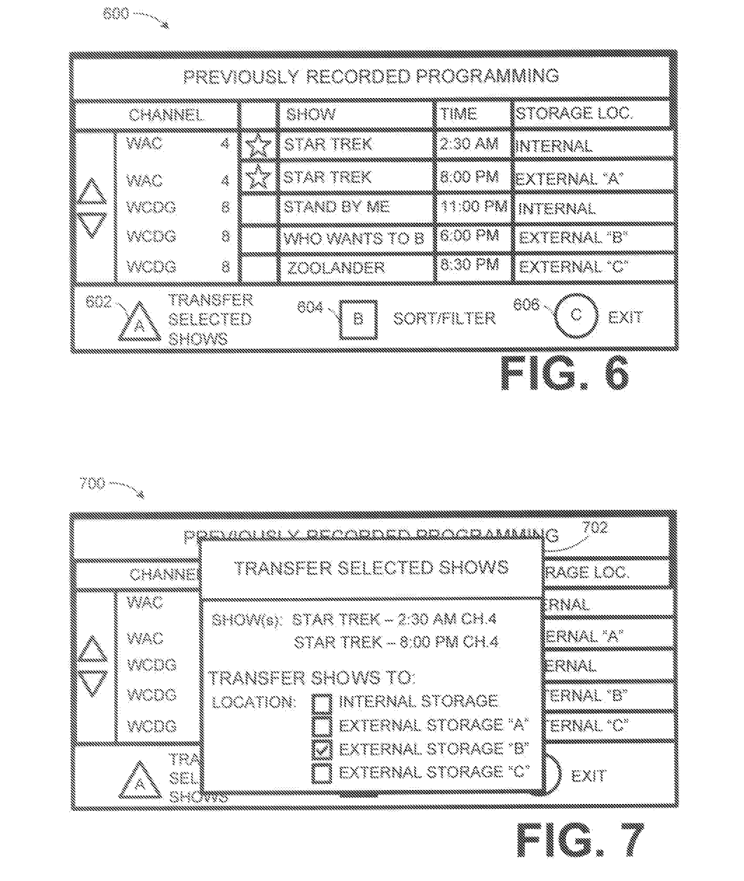

Looking now to FIG. 6, an exemplary display 600 of a plurality of instances of media content that were previously recorded or otherwise stored to storage locations associated with DVR 102. For example, the episode of Star Trek referred to in the display 500 of FIG. 5 is depicted as being recorded at 8:00 PM and is listed as being stored to the selected storage location, external storage “A.” Furthermore, another instance of Star Trek is depicted as having been recorded at 2:30 a.m. and stored to internal storage 218. Other programming recorded at various times on channel 8 are depicted as having been stored to internal storage 218, external storage “B” 220b, and external storage “C” 220c.

Furthermore, the user is provided with a number of selections 602, 604, 606 indicating respective operations to perform on the plurality of previously stored instances of media content listed in display 600. Specifically, option 602 can be selected to transfer selected shows to another storage location, option 604 can be used to sort and/or filter the displayed media content according to its storage location, and option 606 can be used to exit the display 600. Before selecting an option, the user may select designated media content to perform an operation upon.

FIG. 7 depicts an exemplary display 700 after a user has selected option 602 of display 600 in order to transfer selected shows to a desired storage location. Specifically, as shown in FIG. 6, the instance of media content Star Trek recorded at 2:30 a.m. and the instance of media content Star Trek recorded at 8:00 p.m. have been selected as indicated by the star icons to the left of the respective show titles. Once the option 602a has been selected to transfer the selected shows, the display 700 is depicted within the GUI 306 of DVR 102. Specifically, an options display 702 depicts a listing of the selected media content and accepts an input from the user indicating a destination storage location for the selected media content. According to the example depicted in FIG. 7, the available destination locations are: internal storage 218, external storage “A” 220a, external storage “B” 220b and/or external storage “C” 220c. Here, as indicated by the checkmark next to the external storage “B,” the user has selected to transfer the selected shows to external storage “B” 220b.

DVR 102 can accept the user selection and, in response, proceed to transfer the user selected instances of media content to the selected destination storage location. According to some embodiments, the user can select multiple storage locations, including the storage location that the instance of media content already resides on in order to, for example, provide a copy of the instance of media content.

It should be understood that in some embodiments, after transferring the selected instances of media content, the original instance of media content may be deleted (i.e., equivalent to a move operation). However, in other embodiments, the instance of media content is copied to the selected storage location while leaving the original in tact. Such DVR behavior, specifying whether to move or copy the media content, could be pre-programmed or user-selectable.

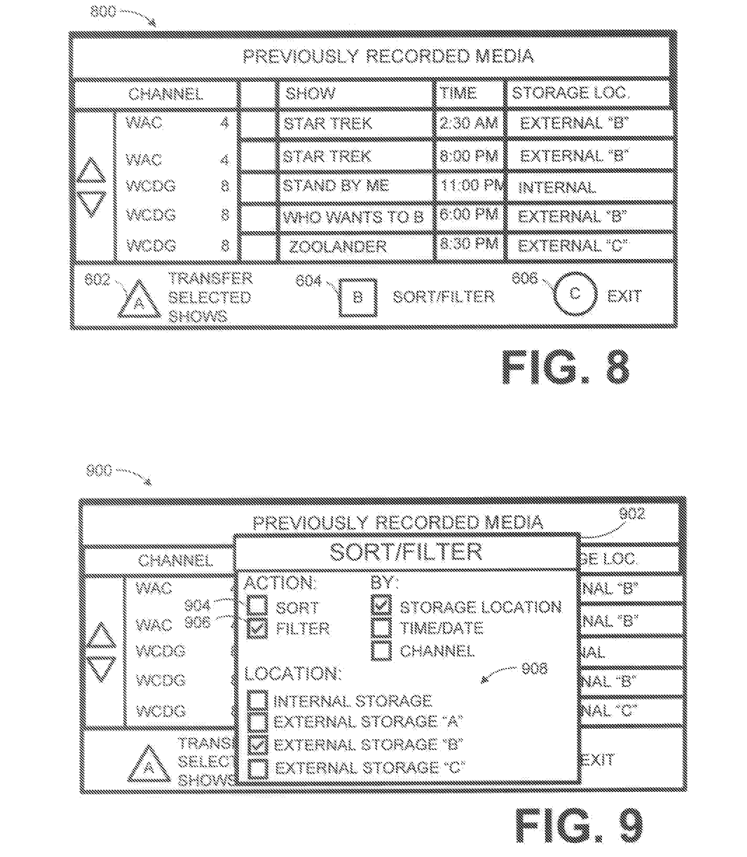

At a time after the user has elected to transfer the selected shows to the desired storage location, the DVR 102 may be configured to update the display to reflect the new storage location of the selected instances of media content. For example, FIG. 8 depicts an updated display 800 showing that the episodes of Star Trek recorded on channel 4 at 2:30 a.m. and at 8:00 p.m., respectively, are now stored to storage location External “B.”According to some embodiments, this updated display may not reflect the changes until after the media content has been completely copied to the updated storage location. However, in other embodiments, the media content need not be completely transferred to the destination storage location before displaying its new location. According to further embodiments a progress bar may be added to display 800 to indicate how much of each instance of media content has been transferred to the destination storage location.

FIG. 9 depicts an exemplary display 900 after a user has selected option 604 from the display 800 of FIG. 8. Specifically, option 604 causes the sort/filter user interface 902 to be displayed within the GUI 306 provided by DVR 102. Sort/filter display 902 can accept inputs indicating whether the user would like to display the previously recorded instances of media content by sorting (i.e. via sort option 904) or filtering (i.e. via filter option 906) in various ways. According to one embodiment, the user can select to sort and/or filter the displayed instances of media content by the storage location of the instances of media content.

In the case that the user desires to sort the media content by storage location, the user selects the sort option 904. In such a case, the resulting media content listing is grouped by storage location in, for example, an ascending or descending order.

However, according to the indicated checkmarks appearing within the exemplary sort/filter user interface 902, the user has requested to filter the instances of media content by storage location. Once the user has selected that the operation is dependent upon the storage location, DVR 902 can update interface 902 to include a location selection portion 908. Location selection portion 908 can provide selection boxes to allow the user to indicate a storage location for the sort or filter operation. Accordingly, the user is requested to select which storage location to perform the operation upon. According to the example of FIG. 9, the user has selected (via the indicated checkmark next to “External Storage B”) to filter the media content by viewing only the content stored to external storage device “B” 220b.

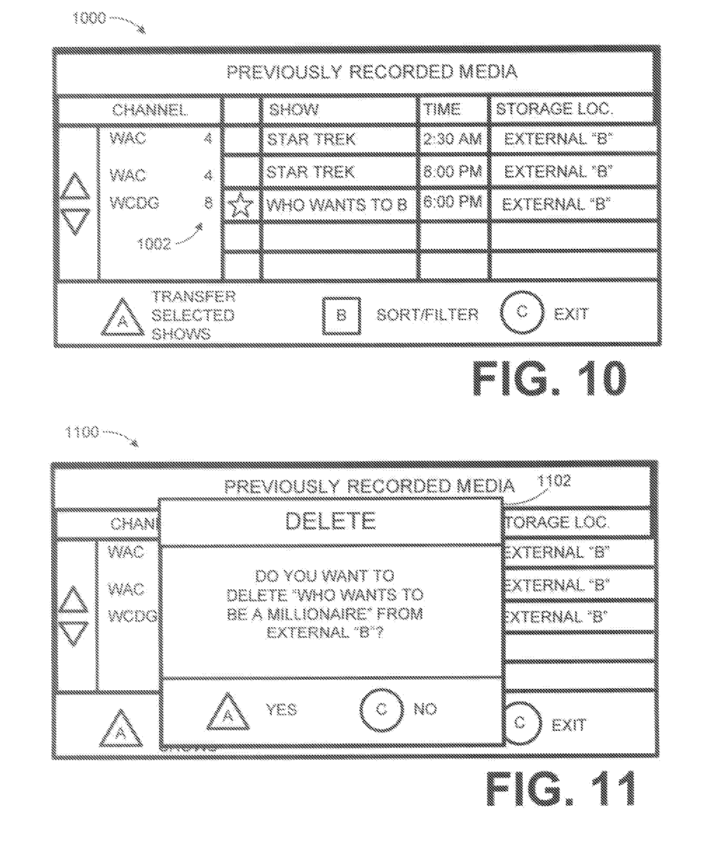

FIG. 10 depicts a display 1000 showing an updated listing of previously recorded instances of media content as filtered by the user selection received in sort/filter display 902. As depicted, only the programming listed in the initial display 800 of FIG. 8 that is stored to external storage “B” 220b is now displayed in the updated display 1000 of FIG. 10.

Some users may wish to use the sort and/or filter features in order to assist in the management of media data associated with a DVR 102. According to some embodiments, a user can designate a particular storage location as having media content related to a particular theme. For example, a user may wish to use external storage “B” 220b as an archive of all recorded Star Trek episodes. Accordingly, by sorting and/or filtering content by location, a user can quickly determine if any media content associated with external storage “B” 220b should be deleted or moved.

A user looking at the instances of media content depicted in display 1000 can quickly determine that the instance of “Who Wants to Be a Millionaire” 1002, recorded at 6:00 p.m. and stored to external storage “B” 220b, is not an episode of Star Trek. Thus, the user can decide to move the media content instance of “Who Wants to Be a Millionaire” to another storage device, such as internal storage 218 using the media content transfer embodiments described above. However, according to other embodiments, the user may wish to simply delete the episode of Who Wants to Be a Millionaire from external storage “B.”

Accordingly, FIG. 11 depicts a display 1100 which can be displayed after a user selects an instance of media content from the previously recorded media listing to be deleted from a desired storage location. For example, the user can highlight or “star” the selected instance(s) of media content to be deleted from its respective storage location. According to some embodiments, the user may, once the instance of media content is highlighted, press a delete button on the input device 236. A confirmation box 1102 can be displayed in order to confirm the deletion of the selected instance of media content to ensure that the user does not inadvertently delete an instance of media programming.

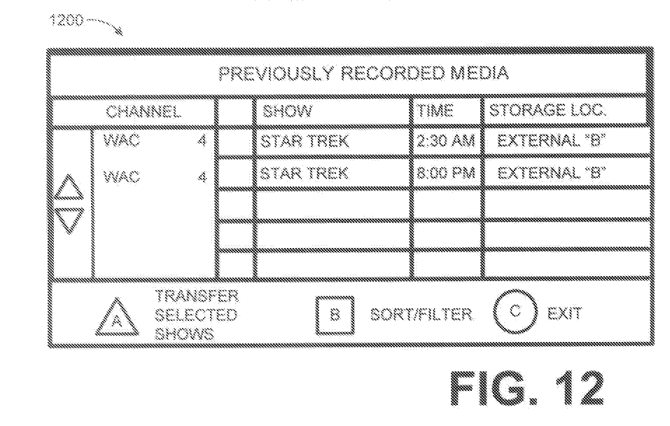

FIG. 12 depicts an exemplary display 1200 depicting a revised listing of the instances of media content after the selected instance of media content has been deleted. Here, the episode of “Who Wants to be a Millionaire” has been deleted from the storage location designated external “B”, leaving only the two depicted Star Trek episodes.

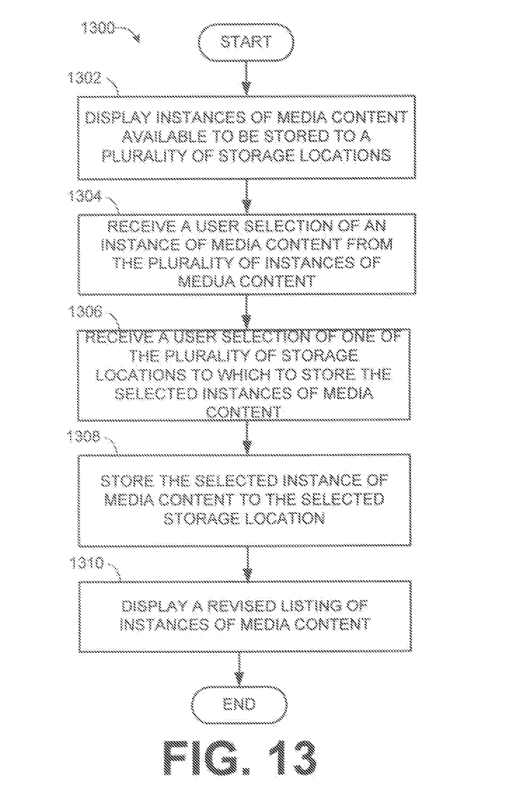

FIG. 13 depicts an exemplary process 1300 which can be executed by a digital media device having selectable media content storage locations. At block 1302, instances of media content available to be stored to a plurality of storage locations can be displayed. At block 1304, a user selection of an instance of media content from the plurality of instances of media content can be received. At block 1306, a user selection of at least one of the plurality of storage locations to which to store the selected instances of media content can be received. At block 1308, the selected instances of media content can be stored to the selected storage location. At block 1310, a revised listing of the instances of media content can be displayed to reflect any changes.

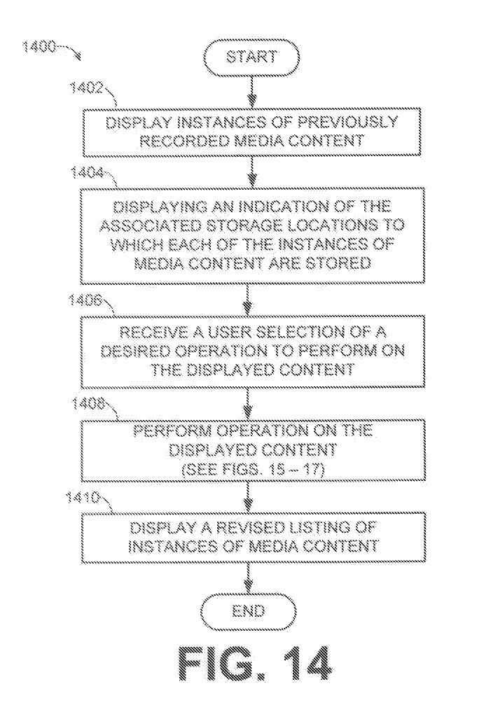

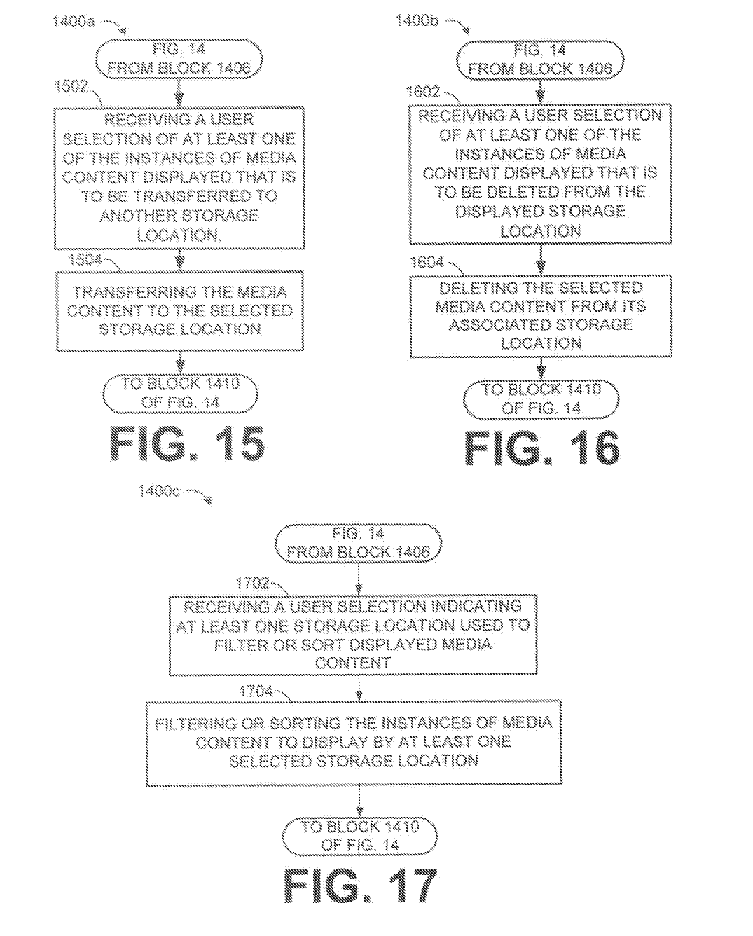

FIG. 14 depicts a process 1400 which can be implemented by a digital media device and used for selecting a desired storage location of previously recorded media content. At block 1402, instances of previously recorded media content can be displayed. At block 1404, an indication of the associated storage locations to which each of the instances of media content are stored can also be displayed. At block 1406, a user selection of a desired operation that can be performed on the displayed content can be received. For example, the user selection of the desired operation could include, among others, a request that selected instances of media content be transferred to another storage location, a user selection that an instance of media content is to be deleted from its associated storage location, and/or a user selection indicating that media content is to be filtered or sorted in a user interface based on its respective storage location. At block 1408, the desired operation is performed. A number of exemplary embodiments of such operations are described below with respect to FIGS. 15-17. At block 1410, a revised listing of the instances of media content can be displayed.

FIG. 15 depicts a process 1408a for performing the user-selected operation on the displayed content of the process of FIG. 14. Specifically, the user-selected operation of process 1408a is a transfer of media content from a first storage location to a second storage location. At block 1502, a user selection of at least one of the instances of media content displayed that is to be transferred to another storage location is received. At block 1504, the selected instance of media content is transferred to the selected storage location.

FIG. 16 depicts a process 1408b for performing the user-selected operation on the displayed instances of media content as described in FIG. 14. Specifically, the user-selected operation of process 1408b is a deletion of media content from a selected storage location. At block 1602, the user selection of at least one of the instances of media content displayed that is to be deleted from its associated storage location is received. At block 1604, the selected media content is deleted from its associated storage location.

FIG. 17 depicts a process 1408c for performing the user-selected operation on the displayed content as described in FIG. 14. Specifically, the user-selected operation of process 1408c is the sorting of media content by at least one selected storage location. At block 1702 a user selection indicating at least one storage location used to filter or sort displayed media content is received. At block 1704 the displayed instances of media content are filtered or sorted by the at least one storage location and displayed within a user interface.

Conditional language, such as, among others, “can,”. “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, steps, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the preferred embodiments of the systems and methods described herein in which steps or functions may be deleted, executed out of order from that shown or discussed, including substantially concurrently or in reverse order, depending on the functionality involved, as would be understood by those reasonably skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A computer program embodied in a computer-readable medium and executable by a digital media device, the computer program comprising:
logic configured to display a plurality of instances of media content available to be stored to a plurality of storage locations associated with the digital media device in a graphical user interface provided by the digital media device;
logic configured to receive a user selection of an instance of media content from the plurality of instances of media content displayed in the graphical user interface;
logic configured to display, in response to receiving the user selection of the instance of media content from the plurality of instances of media content, a selection of one of the plurality of storage locations to which to store the selected instance of media content; and
logic configured to receive a user selection of at least one the plurality of storage locations to which to store the selected instances of media content.

2. The computer program of claim 1, further comprising:
logic configured to store the user selection of the instance of media content to the user selected storage device.

3. The computer program of claim 2, further comprising:
logic configured to display a revised listing of instances of media content at a time after receiving the user selection of the at least one of the plurality of storage locations to which to store the selected instances of media content.

4. The computer program of claim 1, wherein the plurality of storage locations comprises an internal storage medium located internal to the housing of the digital media device and an external storage medium located externally from the housing of the digital media device.

5. The computer program of claim 1, wherein the listing of instances of media content available to the plurality of storage locations represent instances of media content available for recording by the digital media device at a future time.

6. The computer program of claim 1, wherein the listing of instances of media content available to be stored to the plurality of storage locations represent previously recorded instances of media content.

7. The computer program of claim 6, further comprising logic configured to display an indication of the associated storage locations to which each of the instances of media content are stored while displaying the plurality of instances of media content available to be stored to the plurality of storage locations associated with the digital media device in the graphical user interface provided by the digital media device.

8. The computer program of claim 7, further comprising logic configured to filter the instances of media content displayed in the graphical user interface by at least one selected storage location.

9. The computer program of claim 7, further comprising logic configured to receive a user selection of at least one of the instances of media content displayed that is to be transferred from a first storage location to a second storage location.

10. The computer program of claim 7, further comprising logic configured to receive a user selection of at least one of the instances of media content displayed that is to be deleted from its current storage location.

11. The computer program of claim 1, wherein the media device is a digital video recorder (DVR).

12. A method comprising:
displaying a plurality of instances of media content available to be stored to a plurality of storage locations associated with a digital media device in a graphical user interface provided by the digital media device;
receiving a user selection of an instance of media content from the plurality of instances of media content displayed in the graphical user interface;
displaying, in response to receiving the user selection of the instance of media content from the plurality of instances of media content, a selection of one of the plurality of storage locations to which to store the selected instance of media content; and
receiving a user selection of at least one the plurality of storage locations to which to store the selected instances of media content.

13. The method of claim 12, further comprising:
storing the user selection of the instance of media content to the user selected storage location.

14. The method of claim 13, further comprising:
displaying a revised listing of instances of media content at a time after receiving the user selection of the at least one of the plurality of storage locations to which to store the selected instances of media content.

15. The method of claim 12, wherein the plurality of storage locations comprises an internal storage medium located internal to the housing of the digital media device and an external storage medium located externally from the housing of the digital media device.

16. The method of claim 12, wherein the listing of instances of media content available to be stored to the plurality of storage locations represent instances of media content available for recording by the digital media device at a future time.

17. The method of claim 12, wherein the listings of instances of media content available to be stored to the plurality of storage locations represent previously recorded instances of media content.

18. The method of claim 17, further comprising:
displaying an indication of the associated storage locations to which each of the instances of media content are stored while displaying the plurality of instances of media content available to be stored to the plurality of storage locations associated with the digital media device in the graphical user interface provided by the digital media device.

19. The method of claim 18, further comprising filtering the instances of media content displayed in the graphical user interface by at least one selected storage location.

20. The method of claim 18, further comprising receiving a user selection of at least one of the instances of media content displayed that is to be transferred from a first storage location to a second storage location.

21. The method of claim 18, further comprising receiving a user selection of at least one of the instances of media content displayed that is to be deleted from its current storage location.

22. A digital media device having logic embodied in a computer-readable medium and executable by a processing device associated with the digital media device, the computer-readable medium comprising:
logic configured to display a plurality of instances of media content available to be stored to a plurality of storage locations associated with the digital media device in a graphical user interface provided by the digital media device;
logic configured to receive a user selection of an instance of media content from the plurality of instances of media content displayed in the graphical user interface;
logic configured to display, in response to receiving the user selection of the instance of media content from the plurality of instances of media content, a selection of one of the plurality of storage locations to which to store the selected instance of media content; and
logic configured to receive a user selection of at least one the plurality of storage locations to which to store the selected instances of media content.

23. The method of claim 22, wherein the media device is a digital video recorder (DVR).
